(19) United States
(12) Patent Application Publication
(10) Pub. No.: US 2010/0281507 A1
(43) Pub. Date: Nov. 4, 2010

(54) Platform for Personal Media Broadcaster based on XML and Method for Setting up IP Automatically

(76) Inventor: Jung-in Choi, Seoul (KR)

Correspondence Address: INTELLECTUAL PROPERTY LAW GROUP LLP, 12 SOUTH FIRST STREET, SUITE 1205, SAN JOSE, CA, 95113, US

(21) Appl. No.: 12/293,791

(22) PCT Filed: Mar. 20, 2007
(86) PCT No.: PCT/KR07/01360

§ 371 Date: Jul. 20, 2010

(30) Foreign Application Priority Data
Mar. 20, 2006 (KR) 10-2006-0025125

(51) Int. Cl. H04N 7/18; H04N 7/173

(52) U.S. Cl. 725/74; 725/112

(57) ABSTRACT

The present invention provides a platform for an XML-based personal media broadcaster, in which TV programs, which are multimedia, are provided to allow a viewer to view a program desired by him or her at a desired time and at a desired place by compositely implementing an open service architecture, a time-shift function and a place-shift function, thus enabling the platform for a personal media broadcaster to be implemented. The present invention includes an XML module (150) for allowing XML-based communication and control protocols to work in conjunction with middleware of the platform, thus enabling the broadcast reception module (120), the storage and playback module (130), and the IP streamer module (140) to work in conjunction with each other. The XML module (150) executes operation commands between the platform for PMB and the wireless terminal so that the operation commands are transmitted in a bidirectional transmission manner.

### TECHNICAL FIELD

The present invention relates to a platform for an XML-based personal media broadcaster, which allows typical TV broadcast programs and wired/cable/satellite/high definition digital broadcast content to be conveniently recorded in the personal video recorder of a service subscriber, thus allowing the service subscriber to view recorded broadcast content anytime and anywhere.

### BACKGROUND ART

Generally, TV broadcasting provides a plurality of programs to an unspecified number of members of the general public in a unidirectional communication manner according to the characteristics of mass media, and each viewer selects a desired one from among a plurality of programs by searching through the channels, and views the selected program, so that broadcast programs are currently planned and provided on the basis of Service Operators (SO).

As an alternative to this broadcasting method, methods of enabling broadcast information to be recorded and viewed at a desired time by constructing devices, such as a Set-Top Box (STB) for receiving broadcast information, a Digital Video Recorder (DVR) for storing the broadcast information in a hard disc and playing the broadcast information, and an IP streamer for transmitting video information to a remote terminal through IP communication, have been recently proposed.

The STB is a platform capable of receiving broadcast programs and being provided with a plurality of services, such as a Video-On-Demand (VOD) service, by the SO.

STBs can be classified into various types of platforms according to the broadcast transmission/reception method or service. That is, there are STBs for respectively receiving terrestrial, cable, satellite, Internet Protocol (IP) and data broadcasts, but it is difficult to personalize these STBs due to the unidirectional reception characteristics thereof.

However, unidirectional reception is also provided with the return path, so that it evolves into a bidirectional service. However, in the case of STBs, it is difficult to variously personalize STBs on the basis of open architecture due to the limitation of the processor capacity of the platform, the bandwidth of the return path, etc.

Further, in the case of Tivo, in the U.S., a Digital Video Recorder (DVR), having a time-shift function enabling broadcast programs to be stored in a hard disc and to be played and viewed at a desired time, has been developed, and can be personalized through working in conjunction with Electronic Program Guide (EPG) information. However, this method is also problematic in that the personalization of the DVR is difficult due to the characteristics of a limited and closed platform.

Finally, in the case of Sling Media, in the U.S., a sling box, which is an IP streamer for performing the function of transmitting broadcast programs to a remote place over an IP communication network, that is, a place-shift function, has been developed and is provided. However, this sling box is also problematic in that setting and operation required for coupling with the function of a STB or DVR, or required for personalization, are very difficult due to the characteristics of a functionally limited and closed platform.

### DISCLOSURE

### Technical Problem

An object of the present invention, devised in order to solve the above problems, is to provide a scheme for allowing a person to view a program desired by him or her, among a plurality of broadcast programs, at a desired time and at a desired place through a platform for a Personal Media Broadcaster (PMB), so that the selection of broadcast programs is personalized, thus providing higher value to viewers.

Another object of the present invention is to provide a service, which is personalized through working in conjunction with a personalized Database (DB) using eXtensible Markup Language (XML), which is an open Internet standard language, as a method of controlling the storage, play and transmission of broadcast programs when the broadcast programs are stored, played or transmitted using a hard disc in a desired manner.

A further object of the present invention is to provide an automatic setup algorithm for conveniently setting up the Internet IP address of a platform using a personal sharing device in a home.

### Technical Solution

In order to accomplish the above objects, the present invention provides a platform for an eXtensible Markup Language (XML)-based Personal Media Broadcaster (PMB), the platform storing broadcast signals received through wired/wireless communication and enabling the broadcast signals to be played on a TV, or transmitting the broadcast signals in an Internet Protocol (IP) mode and enabling the broadcast signals to be viewed from a remote place, comprising a broadcast reception module (120) including a decoder and encoder for decoding the broadcast signals received through broadcasting media so that the broadcast signals are output through a terminal, connected in a wired or wireless manner; a storage and playback module (130) including memory and a central processing unit (CPU) to store the broadcast signals received from the broadcast reception module in a hard disc and to play the broadcast signals; an IP streamer module (140) for transmitting broadcast programs, stored in the hard disc through the storage and playback module (130), to a wireless terminal located at a remote place through IP communication using an IP sharing device; a remote service module (160), which is a client program module executed in the wireless terminal, the remote service module including a multimedia player enabling control of the platform for the PMB and viewing of programs; and an XML module (150) for allowing XML-based communication and control protocols to work in conjunction with middleware of the platform, thus enabling the broadcast reception module (120), the storage and playback module (130), and the IP streamer module (140) to work in conjunction with each other, the XML module (150) executing operation commands between the platform for the PMB and the wireless terminal so that the operation commands are transmitted in a bidirectional transmission manner.

Preferably, the IP streamer module (140) may perform IP communication, set up using an internal IP address, with the wireless terminal located at the remote place in a P2P manner using an IP sharing device.

Preferably, the XML module (150) may receive a command for channel searching or scheduled recording from the remote service module (160), execute the command, and transmit information stored in the hard disc to the remote service module (160).

Preferably, the IP streamer module (140) may support a Universal Plug and Play (UPnP) Internet Gateway Device (IGD) so that middleware can directly support port mapping information of a Network Address Translation (NAT) router.

Preferably, the broadcast signals may comprise moving image files transmitted from a Closed Circuit Television (CCTV), a video camera, or a home network server.

Preferably, the remote service module may provide an Electronic Program Guide (EPG) screen and information about the platform for the PMB.

In addition, the present invention provides a method for automatically setting up an Internet Protocol (IP) address in a platform for an eXtensible Markup Language (XML)-based Personal Media Broadcaster (PMB) for storing broadcast signals received through wired/wireless communication and enabling the broadcast signals to be played on a TV, or transmitting the broadcast signals in an IP mode and enabling the broadcast signals to be viewed from a remote place, the method comprising a step (S10) of determining whether information can be obtained from a Dynamic Host Configuration Protocol (DHCP) server; a step (S11) of manually inputting an IP address if it is determined that an IP address or the like cannot be obtained at the step (S10), and a step (S20) of determining whether an assigned IP address is a private address if it is determined that the information can be obtained from the DHCP server; a step (S30) of determining whether an Internet Gateway Device (IGD), supporting Universal Plug and Play (UPnP), is present if it is determined that the IP address is a private address; and a step (S40) of automatically setting up a Network Address Translation (NAT) table of the IGD if it is determined that the IGD supporting the UPnP is present.

Preferably, the private address may include a band corresponding to one of a band from 10.0.0.0 to 10.255.255.255, a band from 172.16.0.0 to 172.31.255.255, and a band from 192.168.0.0 to 192.168.255.255.

Preferably, the method may further comprise a step (S21) of completing automatic IP address setup if it is determined that the IP address is not a private address, and then performing an interworking test.

Preferably, the method may further comprise a step of a user personally setting up the NAT table of the IGD if it is determined that no IGD supporting the UPnP is present.

### ADVANTAGEOUS EFFECTS

As described above, a platform for an XML-based Personal Media Broadcaster (PMB) according to the present invention is advantageous in that TV programs, which are multimedia, are provided to allow a viewer to view a program desired by him or her at a desired time and at a desired place by compositely implementing an open service architecture, a time-shift function and a place-shift function, thus enabling the platform for a personal media broadcaster to be implemented.

Further, the present invention provides an independent service interworking channel, thus easily implementing a bidirectional broadcasting service function in a conventional broadcast reception platform.

Further, the present invention can receive video data input, obtained from a Closed Circuit TV (CCTV), a video camera, or a home gateway, which is installed in a home, in addition to broadcast programs, through the PMB, and can store or play the received video data, or can transmit the received video data to a remote platform, thus enabling the PMB platform to work in conjunction with various services.

Although the technical spirit of the platform for an XML-based PMB according to the present invention has been described with reference to the attached drawings, such description is intended to illustrate preferred embodiments of the present invention, and is not intended to limit the present invention. Further, those skilled in the art will appreciate that various modifications, additions and substitutions are possible, without departing from the scope and spirit of the invention.

### DESCRIPTION OF DRAWINGS

FIG. 1 is a diagram showing the overall construction of a platform for an XML-based personal media broadcaster according to the present invention;

FIGS. 2 and 3 are diagrams showing the internal construction of a Personal Media Broadcaster (PMB) according to the present invention;

FIG. 4 is a view showing the configuration of PMB software and the detailed configuration of an IP streamer according to the present invention;

FIG. 5 is a diagram showing an example of the XML-based remote control tag of a platform for an XML-based personal media broadcaster according to the present invention;

FIG. 6 is a diagram showing a user interface for automatically setting up the IP address of the PMB;

FIG. 7 is a flowchart showing a process for automatically setting up the IP address of the PMB of FIG. 6;

FIG. 8 is a view showing the screen of the control module of a client side using a platform for an XML-based PMB according to the present invention; and

FIG. 9 is a view showing a smart EPG module and a PMB information module provided by the PMB.

### BEST MODE

Hereinafter, a platform for an eXtensible Markup Language (XML)-based Personal Media Broadcaster (PMB) according to embodiments of the present invention will be described in detail with reference to the attached drawings.

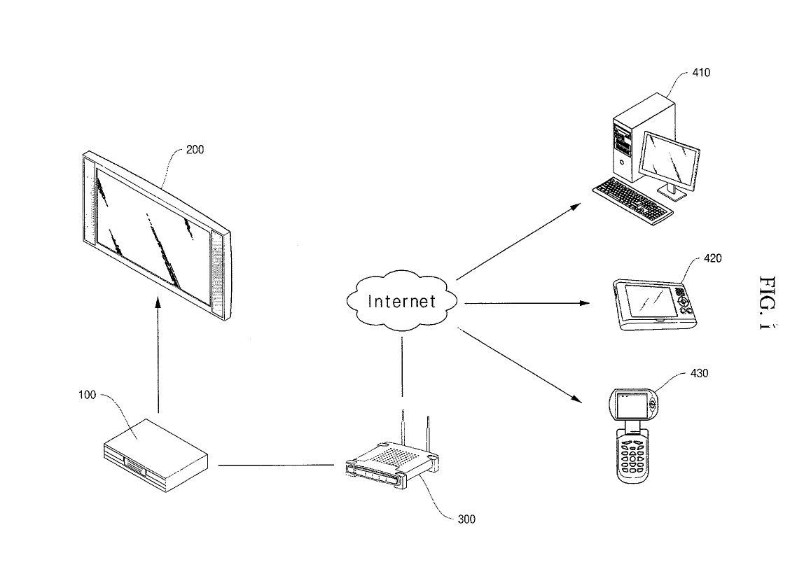

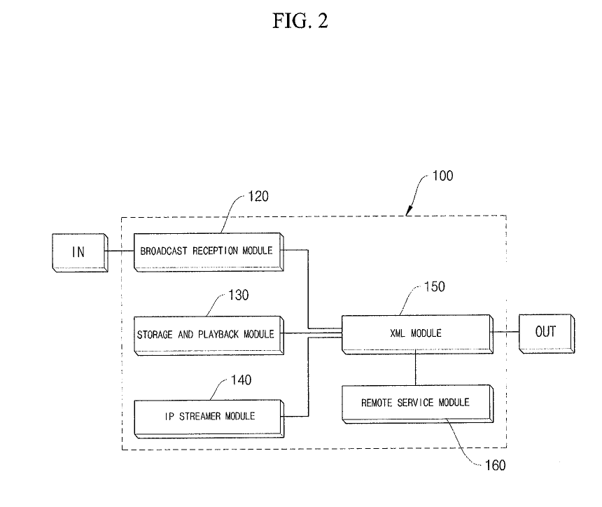

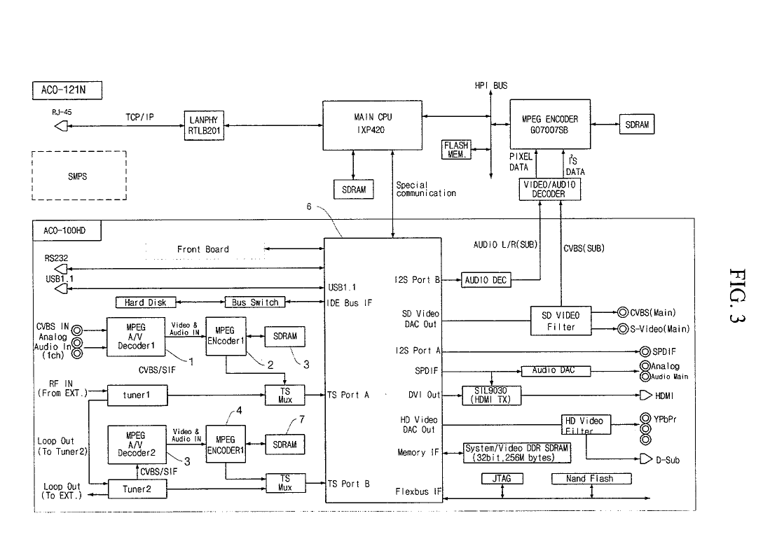

FIG. 1 is block diagram showing the overall construction of a platform for an XML-based PMB according to the present invention, and FIGS. 2 and 3 are diagrams showing the internal construction of the PMB according to the present invention.

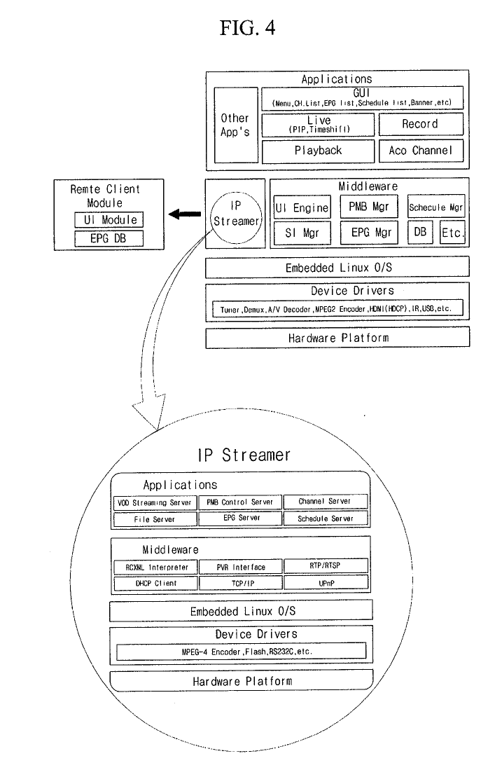

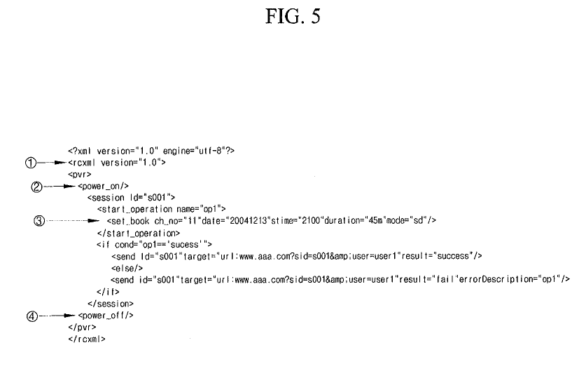

FIG. 4 is a view showing the configuration of PMB software and the detailed configuration of an IP streamer according to the present invention, and FIG. 5 is a diagram showing an example of the XML-based remote control tag of a platform for an XML-based PMB according to the present invention.

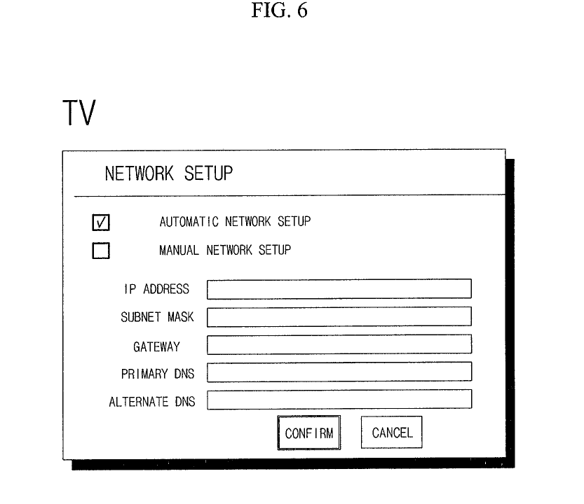

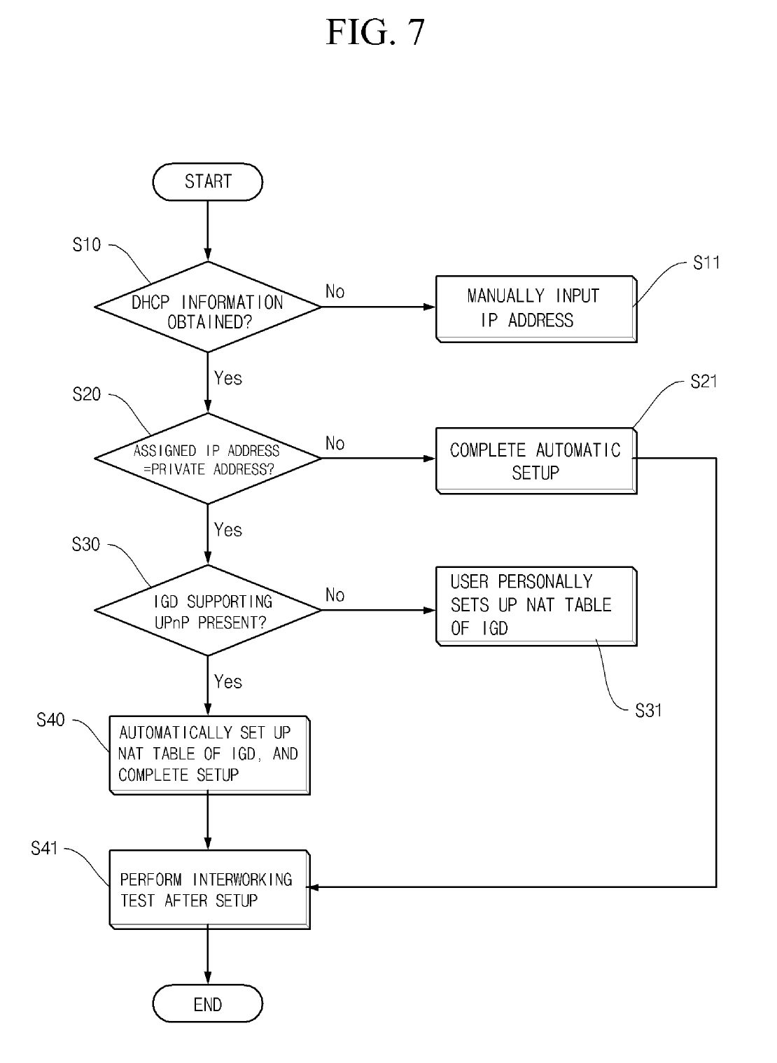

Further, FIG. 6 is a diagram showing a user interface for automatically setting up the IP address of the PMB, and FIG. 7 is a flowchart showing a process for automatically setting up the IP address of the PMB of FIG. 6.

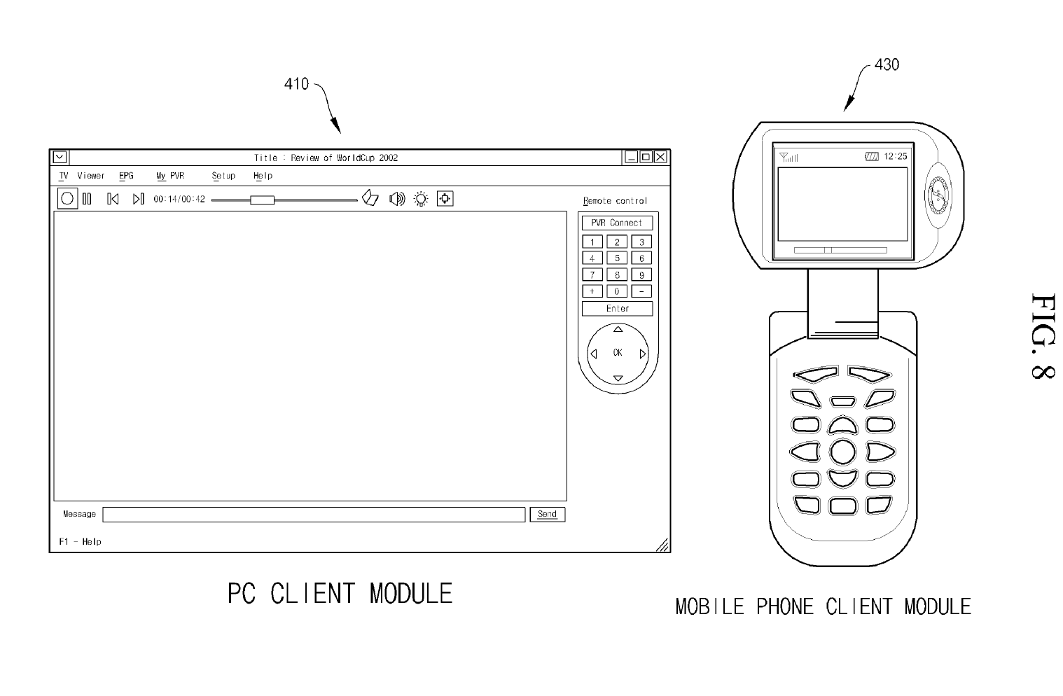

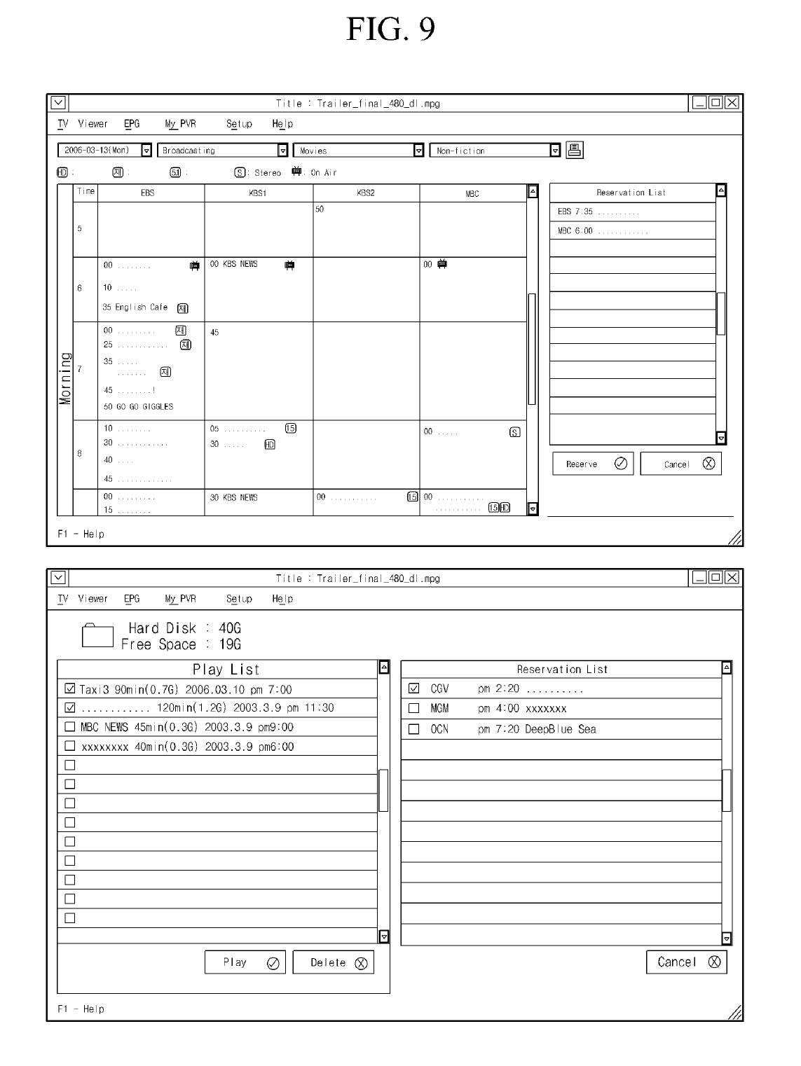

Further, FIG. 8 is a view showing the screen of the control module of a client side using a platform for an XML-based PMB according to the present invention, and FIG. 9 is a view showing a smart Electronic Program Guide (EPG) module and a PMB information module provided by the PMB.

The present invention proposes a platform for an XML-based PMB implemented as a single platform in which the functions of three products, that is, a Set-top box (STB), a Digital Video Recorder (DVR) and an IP streamer, are combined with each other, constructs the single platform in the form of an XML-based open standard platform, and provides the XML-based open standard platform as a personal media platform.

That is, the present invention is implemented to remove the difficulty of the combination of various platforms for three separate functions, construct a bidirectional service channel as an open channel separate from a broadcast reception channel, and provide the open channel, thus facilitating working in conjunction with a wired/wireless Internet-based service platform.

Since the wired/wireless Internet-based service platform facilitates a strong Database (DB) interworking-based personalized service, unlike electronic appliance platforms, such as a PMB, an STB, and a DVR, technology that enables the Internet-based personalized service to work in conjunction with the PMB platform has been developed. This personalized service interworking technology is implemented as a new XML-based open standard protocol.

As shown in FIG. 1, a Personal Media Broadcaster (PMB) 100 according to the present invention stores broadcast signals, received through wired/wireless communication, in a hard disc provided therein, and transmits the broadcast signals to a TV 200, or transmits the broadcast signals through an IP sharing device 300 in an IP mode, thus enabling the broadcast signals to be viewed through a PC 410 or a portable terminal 420 or 430 from a remote place.

In this case, in order to select, store, play and transmit a personalized program, a platform capable of accommodating an open standard protocol is designed. The protocol is created using an XML-based standard language, thus enabling services provided over the wired/wireless Internet to easily work in conjunction with the platform.

FIGS. 2 and 3 are a schematic block diagram and a detailed block diagram showing the internal construction of the PMB according to the present invention.

The internal construction of the PMB 100 of FIG. 2 includes five modules defined according to the respective functions thereof, as shown in FIG. 3.

That is, the PMB includes five modules, namely, 1) a broadcast reception module, 2) a storage and playback module, 3) an IP streamer module, 4) an XML module, and 5) a remote service module.

The broadcast reception module 120 is a module functioning as a typical Set-Top Box (STB), and includes decoders 1 and 3 and encoders 2 and 4 so as to receive broadcast signals for broadcast programs, transmitted from respective broadcasting companies, through broadcasting media, such as terrestrial, cable, satellite or IP media, and to decode the broadcast signals so that they can be output through a terminal.

The storage and playback module 130 is a module functioning as a typical DVR (recorder), and includes memory 6 and 7 and a Central Processing Unit (CPU) 5 so as to store the broadcast signals, received from the broadcast reception module, in a hard disc, or to play the broadcast signals from the hard disc.

The IP streamer module (140) functions to transmit broadcast programs, stored in the hard disc through the storage and playback module 130, to a PC or a portable terminal located in a remote place through IP communication using the IP sharing device.

At this time, since transmission is performed between the PMB and a remote platform in a P2P manner, it is important to obtain the IP address of the PMB. The main purpose of the PMB is to be used in typical electronic home appliances, and thus the IP address of the PMB must be generally set to an internal IP address through a sharing device.

The XML module 150 functions to allow XML-based communication and control protocols to work in conjunction with the middleware of the platform, thus enabling the broadcast reception module 120, the storage and playback module 130, the IP streamer module (140), and the remote service module 160, which will be described later, to work in conjunction with each other.

That is, the XML module 150 is a module for executing various operation commands to transfer various operation commands in a bidirectional transmission manner between the PMB 100 and the remote terminal, such as by receiving a command for channel searching or scheduled recording from the remote service module 160 and executing the command, or by transmitting information, stored in the hard disc, to the remote service module 160.

The XML module 150 functions to automatically execute a remote service scenario created using XML-based standardized tags when the remote service scenario is received.

The remote service module 160 is a client program module executed in a PC or a portable terminal, and includes a multimedia player therein to enable the viewing of programs as well as the control of the PMB while communicating with the XML module provided in the PMB.

FIG. 4 is a diagram showing the configuration of software and an IP streamer of the platform for the XML-based PMB according to the present invention.

As shown in the drawing, the IP streamer supports a Universal Plug and Play (UPnP) Internet Gateway Device (IGD) so that middleware can directly support the port mapping information of a Network Address Translation (NAT) router.

In this case, the term “Universal Plug and Play (UPnP)” means the standardized name of protocols enabling a network to automatically recognize the connection of devices and to connect corresponding devices when devices, such as PCs, peripheral devices or wireless devices, are connected to each other.

For this operation, the NAT is set to allow external traffic in a required port by the application requesting an XML message-based Simple Object Access Protocol (SOAP) action, and by the IGD executing a corresponding function.

In detail, as shown in the drawing, the XML module requests the IGD to perform port mapping, and the IGD, which received the request, receives a SOAP action, performs port mapping and revises a NAT table, thus allowing traffic from the outside.

FIG. 5 is a diagram showing an example of the XML-based remote control tag of the platform for the XML-based PMB according to the present invention.

As shown in the drawing, remote service scenario information is tag information indicating the operations of,

1) declaring the version of XML,

2) operating the PMB,

3) scheduling the recording of a program to be telecasted for 45 minutes, starting from 21:00 in channel 11 on a scheduled date of Dec. 13, 2004, and

4) stopping the PMB.

FIG. 6 illustrates a user interface for automatically setting up the IP address of the PMB.

As shown in the drawing, for network setup, there is a method of searching for a Dynamic Host Configuration Protocol (DHCP) server and of obtaining and setting up an IP address when an item corresponding to “automatic network setup” is marked through a user's selection, and of setting up a NAT table when an assigned IP address is a private address and an IGD, supporting UPnP, is present.

FIG. 7 is a flowchart showing the process of automatically setting up the IP address of the PMB of FIG. 6.

As shown in the drawing, whether information can be obtained from a DHCP server is determined at step S10. If it is determined that no IP address is obtained, an IP address is manually input at step S11. If it is determined that information can be obtained from the DHCP server, whether the assigned IP address is a private address is determined at step S20.

In this case, if it is determined that the IP address is a private address, whether an IGD supporting UPnP is present is determined at step S30. If it is determined that the IP address is not a private address, automatic setup is completed at step S21, and an interworking test is performed at step S41.

Further, if it is determined that the IGD supporting UPnP is present, the NAT table of the IGD is automatically set up, thus completing the IP address setup. Thereafter, an interworking test is performed at step S41, thus terminating all automatic network setup steps.

In this case, a private address band includes the following bands,

10.0.0.0 to 10.255.255.255,

172.16.0.0 to 172.31.255.255, and

192.168.0.0 to 192.168.255.255.

FIG. 8 is a view showing the screen of the control module of a client side using a platform for an XML-based PMB according to the present invention.

As described above with reference to FIG. 1, the screen of the client side is provided by a wireless terminal 410, 420 or 430. As shown in the drawing, a viewer can view a recorded broadcast, scheduled in advance by the viewer, or a live broadcast through the screen.

As shown in FIG. 9, the remote service module of the PMB provides the EPG screen and PMB information so that the above-described screen can be provided.

On the EPG screen, scheduled recording is performed while the current situation of the storage space of the PMB is continuously checked, and a list of played programs, a list of scheduled programs, etc. is presented.

Further, broadcast programs are displayed on the screen for respective dates, broadcasting companies, and program genres, thus allowing viewers to easily recognize the current condition of broadcast programs.

When a program is registered on a wired/wireless Internet service site, the remote service module is implemented to provide personalized service and various information services through working in conjunction with various DBs of the service site. For example, it is possible to receive real-time EPG information and to search for a desired program, or to monitor various types of information and to apply for the scheduled recording of monitored information. Further, it is possible to individually transmit EPG information to the PMB of each member's home. Further, the PMB information of each person can be monitored in real time through the remote service module.

Moreover, the remote service module can function as a gateway capable of providing various personalized services, such as a short message service, a data provision service, or an automatic scheduled recording service.

1. A platform for an eXtensible Markup Language (XML)-based Personal Media Broadcaster (PMB), the platform storing broadcast signals received through wired/wireless communication and enabling the broadcast signals to be played on a TV, or transmitting the broadcast signals in an Internet Protocol (IP) mode and enabling the broadcast signals to be viewed from a remote place, comprising:
a broadcast reception module including a decoder and encoder for decoding the broadcast signals received through broadcasting media so that the broadcast signals are output through a terminal, connected in a wired or wireless manner;
a storage and playback module including memory and
a central processing unit (CPU) to store the broadcast signals received from the broadcast reception module in a hard disc and to play the broadcast signals;
an IP streamer module for transmitting broadcast programs, stored in the hard disc through the storage and playback module, to a wireless terminal located at a remote place through IP communication using an IP sharing device;
a remote service module, which is a client program module executed in the wireless terminal, the remote service module including a multimedia player enabling control of the platform for the PMB and viewing of programs; and
an XML module for allowing XML-based communication and control protocols to work in conjunction with middleware of the platform, thus enabling the broadcast reception module, the storage and playback module, and the IP streamer module to work in conjunction with each other, the XML module executing operation commands between the platform for the PMB and the wireless terminal so that the operation commands are transmitted in a bidirectional transmission manner.

2. The platform according to claim 1, wherein the IP streamer module performs IP communication, set up using an internal IP address, with the wireless terminal located at the remote place in a P2P manner using an IP sharing device.

3. The platform according to claim 1, wherein the XML module receives a command for channel searching or scheduled recording from the remote service module, executes the command, and transmits information stored in the hard disc to the remote service module.

4. The platform according to claim 1, wherein the IP streamer module supports a Universal Plug and Play (UPnP) Internet Gateway Device (IGD) so that middleware can directly support port mapping information of a Network Address Translation (NAT) router.

5. The platform according to claim 1, wherein the broadcast signals comprise moving image files transmitted from a Closed Circuit Television (CCTV), a video camera, or a home network server.

6. The platform according to claim 1, wherein the remote service module provides an Electronic Program Guide (EPG) screen and information about the platform for the PMB.

7. A method for automatically setting up an Internet Protocol (IP) address in a platform for an eXtensible Markup Language (XML)-based Personal Media Broadcaster (PMB) for storing broadcast signals received through wired/wireless communication and enabling the broadcast signals to be played on a TV, or transmitting the broadcast signals in an IP mode and enabling the broadcast signals to be viewed from a remote place, the method comprising:
a step of determining whether information can be obtained from a Dynamic Host Configuration Protocol (DHCP) server;
a step of manually inputting an IP address if it is determined that an IP address or the like cannot be obtained at the step, and a step of determining whether an assigned IP address is a private address if it is determined that the information can be obtained from the DHCP server;
a step of determining whether an Internet Gateway Device (IGD), supporting Universal Plug and Play (UPnP), is present if it is determined that the IP address is a private address; and
a step of automatically setting up a Network Address Translation (NAT) table of the IGD if it is determined that the IGD supporting the UPnP is present.

8. The method according to claim 7, wherein the private address includes a band corresponding to one of a band from 10.0.0.0 to 10.255.255.255, a band from 172.16.0.0 to 172.31.255.255, and a band from 192.168.0.0 to 192.168.255.255.

9. The method according to claim 7, further comprising a step of completing automatic IP address setup if it is determined that the IP address is not a private address, and then performing an interworking test.

10. The method according to claim 7, further comprising a step of a user personally setting up the NAT table of the IGD if it is determined that no IGD supporting the UPnP is present.
